(19) United States
(12) Patent Application Publication
(10) Pub. No.: US 2011/0187533 A1
(43) Pub. Date: Aug. 4, 2011

(54) Antenna for Near Field Radio-Frequency Identification and Method and System for Use Thereof

(75) Inventors: Zvi Henry Frank, Elkana (IL); Daniel Zerah, Yehud (IL)

(73) Assignee: MTI WIRELESS EDGE LTD., Rosh Ha'ayin (IL)

(21) Appl. No.: 12/673,690

(22) PCT Filed: Mar. 3, 2008
(86) PCT No.: PCT/IL08/00273

§ 371 Date: Apr. 8, 2010

Related U.S. Application Data
(60) Provisional application No. 60/935,423, filed on Aug. 13, 2007.

(51) Int. Cl. G08B 13/14

(52) U.S. Cl. 340/572.7

(57) ABSTRACT

An antenna array and method of operation are disclosed for providing a very thin antenna arrangement with large coverage area for RFID applications and long distance sensitivity. The antenna arrangement comprises two or more antenna elements, each element comprises a planar spiral of conductive material with a feed terminal at one end of the spiral and preferably at its outer end. Each adjacent couple of antenna elements may be arranged with the direction of rotation of their spiral being in opposite directions. Each antenna element may be fed with RFID signal independently from the other antenna elements and preferably the antenna elements are fed one at a time.

### BACKGROUND OF THE INVENTION

Radio-frequency identification (RFID) systems and methods are widely used in a variety of fields and for a large number of purposes, such as personal electronic ID card, package identification from a distance, etc. The performance (e.g. range of sensing, accuracy of identification, etc.) of a RFID system may depend on various parameters comprising the working frequency, the size of the antennas involved in the transmission and receipt of RFID information, the available/allowable RF power supplied to the transmitting antenna, etc. Naturally, the smaller is the area of the antenna and/or the transmitted power, the shorter is the operational range of a RFID system and the higher is the false identification rate.

### SUMMARY OF THE INVENTION

An antenna array having two or more antenna elements is disclosed. Each antenna element may comprise a planar spiral conductive material having a feed terminal at its outer end. The antenna elements may be arranged in arrays of two or more elements and may have their direction of rotation of the spiral reversed within each adjacent couple of spirals. The antenna elements may be fed with RFID signal and may receive RFID response from a RFID responder such a RFID tag. The RFID signal fed to the antenna elements may be fed sequentially to the antenna elements, one at a time to allow transmission with a maximum allowed RFID power and cover a large area of RFID interrogation.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a RFID system according to some embodiments of the present invention;

FIG. 2 is a schematic illustration of antenna according to embodiments of the present invention;

FIGS. 3, 4 and 5 are schematic geometric illustrations of transmit/receive ranges of an antenna according to embodiments of the present invention with various types of RFID tags;

FIG. 6 is a schematic illustration of an array of antennas according to embodiments of the present invention;

FIG. 7 is a schematic block diagram illustration of a RFID identification system according to some embodiments of the present invention, and

FIG. 8 is a schematic side view illustration of performance curves of antenna array, according to embodiments of the present invention

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In systems using RFID reader, which may comprise for example a processor with memory and a transmitter connected to an antenna, and a responder device, the operation is typically driven by the RFID station, that is a signal transmitted by the RFID station may reach the responder device, may provide it with electrical energy and with a signal carrying detectable information. This information may comprise, for example, an inquiry addressed to the responder device, an identification data of the transmitting antenna, etc. Upon receipt of electrical energy and further upon receipt of data information the responder device processes the received data using a built in processor and accordingly may respond by sending a response to the RFID station.

The mutual performance of a RFID station and a responder (sometimes called also RFID tag) may be a function of various variables, such as the power transmitted by the RFID station, the type and size of the antenna of the RFID station, the type of the RFID tag, the size of the antenna inside the RFID tag, the distance of the RFID tag from the antenna of the RFID station and the nature of the RF permeability of the substance between the antenna of the RFID station and the RFID tag. The mutual performance of a RFID station and a RFID tag may be characterized, according to a non-limiting example, by the distance at which the RFID station may still communicate with the RFID tag, the accuracy of the communication (i.e. the number of correct communication sessions in a given number of transmission sent by the RFID station to the RFID tag), etc.

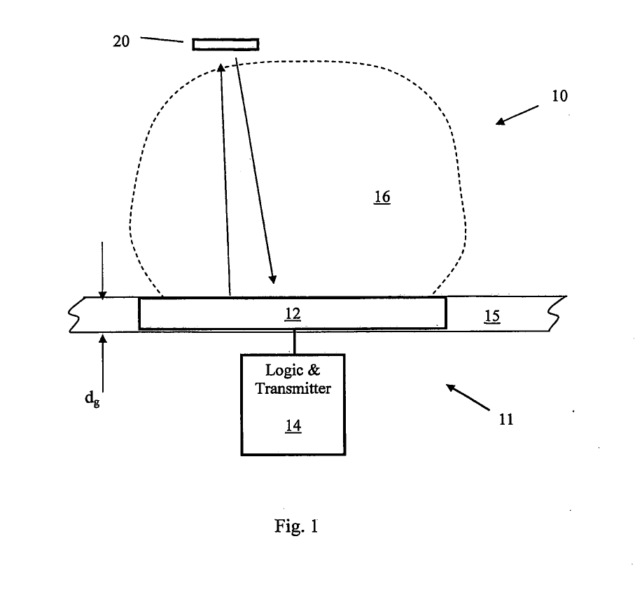

Attention is made now to FIG. 1, which is a schematic illustration of a RFID system 10 according to some embodiments of the present invention. RFID system 10 may comprise a RFID station 11 and a RFID tag 20. RFID station 11 may comprise a logic control and a transmitter 14 connected to antenna 12. According to some embodiments of the present invention antenna 12 may be installed in a construction having rather very little space for installation, specifically when antenna 12 needs to be added to an already existing installation, such as a shelf 15. For example, the space available for antenna 12 may be very narrow, where the distance d_{g} between two consecutive faces of the space where the antenna should be installed may be in the order of 20mm and even as small as few millimeters if the antenna can be used without casing, for example antenna 12 may be embodied on a printed circuit.

For a given RFID tag 20 the sensitivity spatial zone 16 next to antenna 12 in which RFID tag 20 may respond properly to transmission from antenna 12 is illustrated enclosed by a dashed line. The specific shape, height and width of sensitivity spatial zone 16 are dictated, as mentioned above, by various variables. For a given antenna 12 different RFID tags may render different sensitivity spatial zones 16.

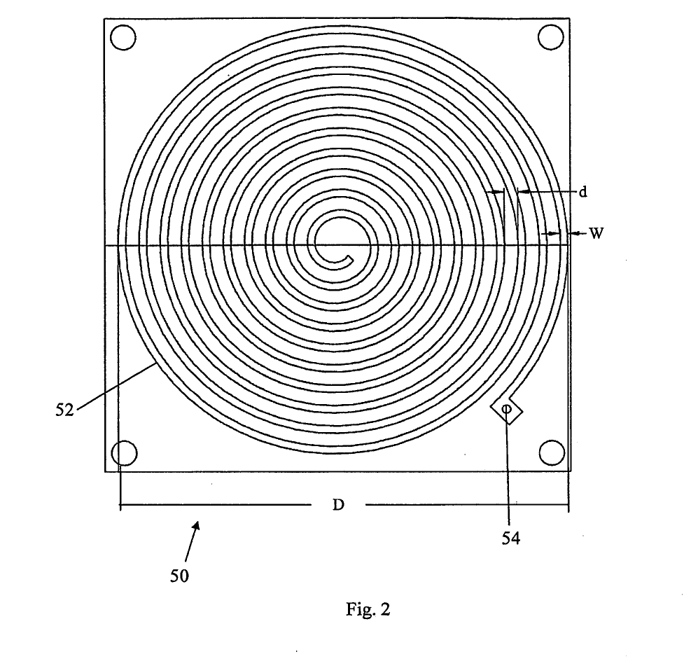

Attention is made now to FIG. 2, which is a schematic illustration of antenna 50 according to embodiments of the present invention. Antenna 50 may be formed substantially by an inbound flat spiral 52 made of a conductive material, with a defined width W and cross section of the conducting material, having a defined distance d between two consecutive windings of the spiral. Antenna 50 may further be provided with a feeding terminal 54 at, for example, the outer end of the spiral. Antenna 50 may have its winding turning inbound clockwise, as illustrated in FIG. 2, or anticlockwise. The conducting material 52 may be placed, or supported, on a substantially flat, isolating material, such as FR4 Epoxyglass substrate or Teflon based. When using Printed Board Circuit (PCB) techniques the width of a board comprising spiral 52 on it may be as low as 1 or 2 mm. The number of windings, the width W of the conducting material 52 and the distance d between windings, as well as the outer diameter D of antenna 50 may be chosen, for example, so that a uniform magnetic field is achieved substantially over the defined active area. The spiral design of antenna 50 makes it a magnetic field antenna with high efficiency and substantially uniform field in the near-field range (approximately in the ranges from zero to, for example, about 50 mm) however, in ranges higher than the near field the working range of the antenna may be as long as, for example, 100 cm. Use of magnetic field RFID tags, e.g. tags having loop antenna, results high sensitivity and high uniformity over substantially the entire area of the RFID system antenna, supports use of small RFID tags and provides low sensitivity to materials with low permeability, such as liquids or metals.

As discussed in brief above, the actual performance of an antenna in a RFID system may be highly dependant on the RFID tag the antenna is operating with. The inventors of the present invention have tested antenna 50 with various types of RFID tags.

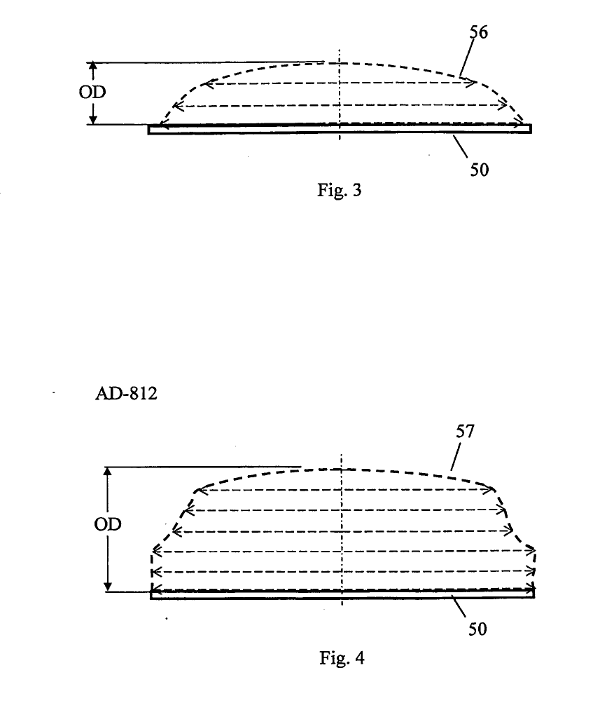

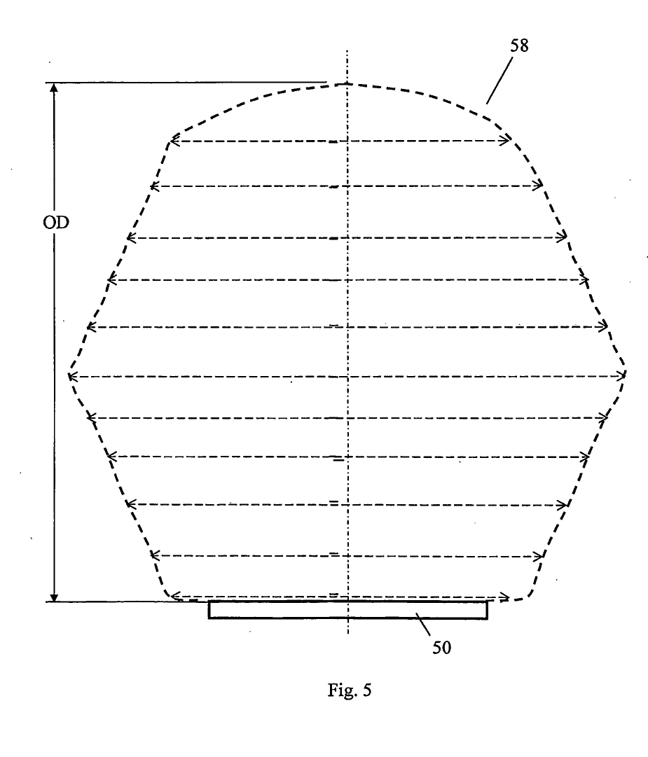

Attention is made now to FIGS. 3, 4 and 5, which are schematic geometric illustrations of transmit/receive ranges of an antenna according to embodiments of the present invention with various types of RFID tags. FIGS. 3, 4 and 5 illustrate a side view diagram of the spatial sensitivity zone of antenna 50 (of FIG. 2) measured when operating with RFID tag IN-26 by RSI ID Technologies, RFID tag AD-812 by Avery Dennison, and RFID tags AD-430/AD-222 made by Avery Dennison, respectively. Such antenna 50 with either one of the above described RFID tags may be used for applications in the near field range.

It should be noted that the curves 56, 57 and 58 have not been drawn to scale, neither with respect to the diameter of antenna 50 nor along their vertical symmetry line, and are given for illustrative purpose mainly.

TABLE 1
RFID tag type IN-26

| Operational Distance | Percentage coverage area |
|---|---|
| (OD) [mm] | (relative to antenna) [%] |
| 0 | >90 |
| 10 | >75 |
| 20 | >50 |
| >20 | NA |

Tag diameter: 9 mm
Frequency: 865-870, 902-928, 950-956 MHz
Transmission power: 30 dBm

TABLE 2
RFID tag type AD-812

| Operational Distance | Percentage coverage area |
|---|---|
| (OD) [mm] | (relative to antenna) [%] |
| 0 | 100 |
| 10 | 100 |
| 20 | 100 |
| 30 | >80 |
| 40 | >70 |
| 50 | >60 |
| >50 | NA |

Tag size: 25.4 mm × 25.4 mm
Frequency: 902-928 MHz
Transmission power: 30 dBm

TABLE 3
RFID tag type AD-430/AD-222

| Operational Distance | Percentage coverage area |
|---|---|
| (OD) [cm] | (relative to antenna) [%] |
| 0 | 150 |
| 10 | >200 |
| 20 | >250 |
| 30 | >300 |
| 40 | >350 |
| 50 | >400 |
| 100 | >350 |
| 120 | >300 |
| 140 | >250 |
| 160 | >200 |
| 180 | >160 |

Tag size: 95.6 × 23.3 mm
Frequency: 860-960 MHz
Transmission power: 30 dBm

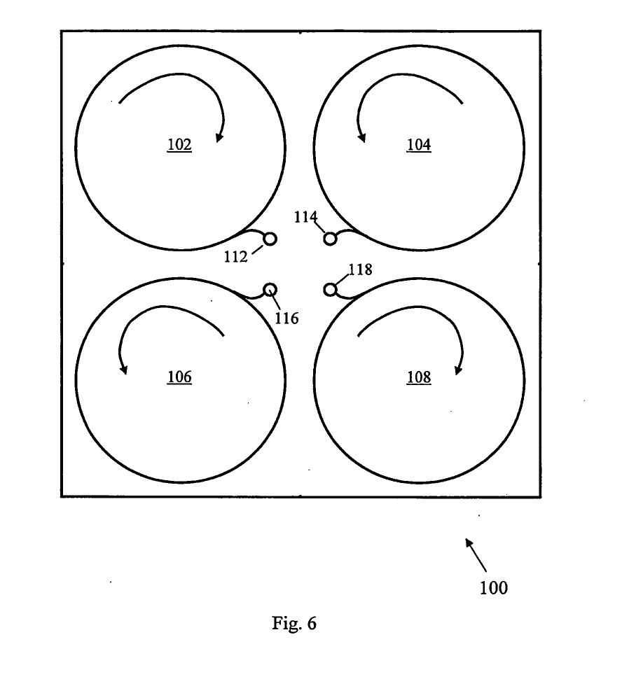

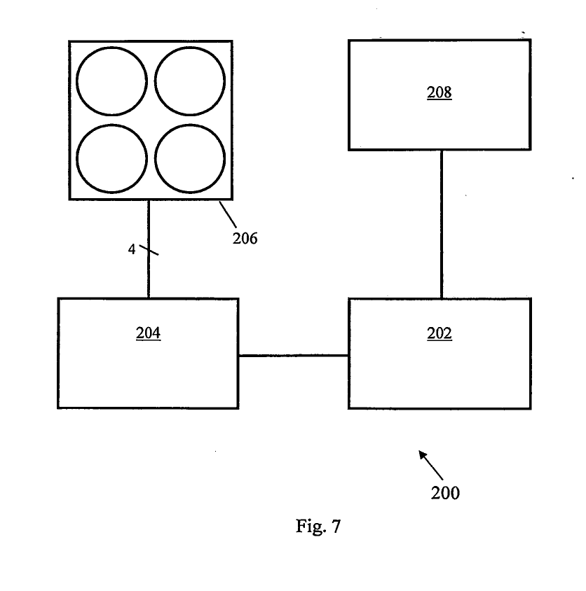

In some situations the available space in an existing installation dictates a very, thin antenna construction, such as that of antenna 50. Regulations or other constrains may dictate limited allowed transmission power and the requirements of operational performance may present a requirement for long range of operational sensitivity range and wide area of coverage. In cases where a very large area needs to be covered by a RFID system, while power constrains may limit the total amount of RF power transmitted from the RFID system at any given time, the system according to embodiments of the invention may comprise a plurality of antennas, such as antenna 50, placed coplanar and radiating in the same direction, to achieve the required coverage area. Attention is made now to FIG. 6, which a schematic illustration of an array 100 of antennas according to embodiments of the present invention. Array 100 may comprise a plurality of antennas 102, 104, 106 and 108, each of which may be such as antenna 50 of FIG. 2. The antennas in array 100 may be placed substantially in one plain and may radiate substantially in the same direction. In the example of FIG. 6 array 100 comprises four antennas yet it would be apparent that array 100 may comprise other number of antennas, smaller or larger than four, as may be needed. In order to not decrease the power transmitted by the antennas due to constant distribution of the power between the pluralities of the antennas 102, 104, 106 and 108, the RF power may be distributed between the antennas of array 80 so that at any given time only one antenna is fed with RF power. Thus, each antenna in array 100 covers substantially the same area and range as if it was operated alone when it is fed with RF energy and the total covered area by array 100 is substantially the sum of areas covered by all of the antennas in array 100. In the example of FIG. 6 RF power may be switched between antennas 102, 104, 106 and 108 so that each antenna is fed with RF power substantially one quarter of a cycle time. It should be noted that when only one antenna, for example antenna 102, in an array is operative the presence of the neighbor antennas 104 and 106 and even 108 has its passive effect on the uniformity and strength of the near-field performance of antenna 102. In order to minimize the disturbing effect of passive antennas 104, 106 and 108, the direction of the rotation of the spiral wound of the antennas may mutually be opposite in each couple of neighbor antennas, as may be seen in FIG. 6. The specific direction of the turn of the spiral wounds in antennas 102, 104, 106 and 108 is indicated by the arc arrows. The above described arrangement of antenna array 100 and the described policy of distribution of RF power among antennas 102, 104, 106 and 108 may ensure a large coverage area without compromising on range, unity and density of magnetic field in the near-field of antenna array 100.

It would be noted that in a RFID system having one source of RF energy an array of antennas, such as array 100, may comprise a large number of antennas, such as antenna 50, arranged in different topological arrangements as may be needed for a given application, thus achieving a large coverage area, a formed coverage area, etc. Practically, the number of antennas in an array according to embodiments of the present invention may be limited mainly by the minimum period of time of energizing each antenna in the cycle which still ensures long enough time of energizing of each antenna to ensure detection of a RFID tag in the required coverage range.

Attention is made now also to FIG. 7, which is a schematic block diagram illustration of a RFID identification system 200 according to some embodiments of the present invention. RFID identification system 200 may comprise a sequencer unit 202, an antenna array switch 204, an antenna array 206 and a control unit 208. Control unit 208 may comprise a RFID reader; user interface means such as an input means and display means, computing unit and storage means. Sequencer unit 202 may control the distribution of RFID transmission energy received from control unit 208 to a desired number time slots, one for each antenna element in antenna array 206. Sequencer unit 202 may provide RFID signal and sequencing signals to antenna array switch 204. Switch 204 may be, for example, a Single Pole Four Throw (SP4T) type of switch which according to a control signal received from sequencer unit 202 may provide a RFID signal to an antenna element in an antenna array, for example four antennas in the example of FIG. 7, of antenna array 206, according to a desired time plan. A RFID response signal received by a currently active antenna element in antenna array 206 may be passed via switch 204 and sequencer unit 202 to control unit 208. Control unit 208 may analyze the received signal and decide whether it represents a valid response and what is the content (i.e. identification of the responding RFID tag) embedded in the response. Typical time duration of a full sequence of sequencer 202 may be, for example, 0.5 Sec. The practical coverage of antenna array 206 is the combination of the specific RFID sensitivity curve of a single antenna element, such as curves 56, 57 or 58, as may correspond to the specific RFID tag in use, for objects with RFID tags whose location dynamics is lower than the typical time of a full sequence of sequencer 202. Control unit 208 may be connectable to additional sets of sequencer, switch and antenna array similar to sequencer unit 202, to SP4T switch 204 and antenna array 206. This possibility is symbolized in FIG. 7 by the dashed-line arrows pointing out of control unit 208. This way, system 200 may, virtually, be expended to cover with RFID interrogating ability area as large as may be required.

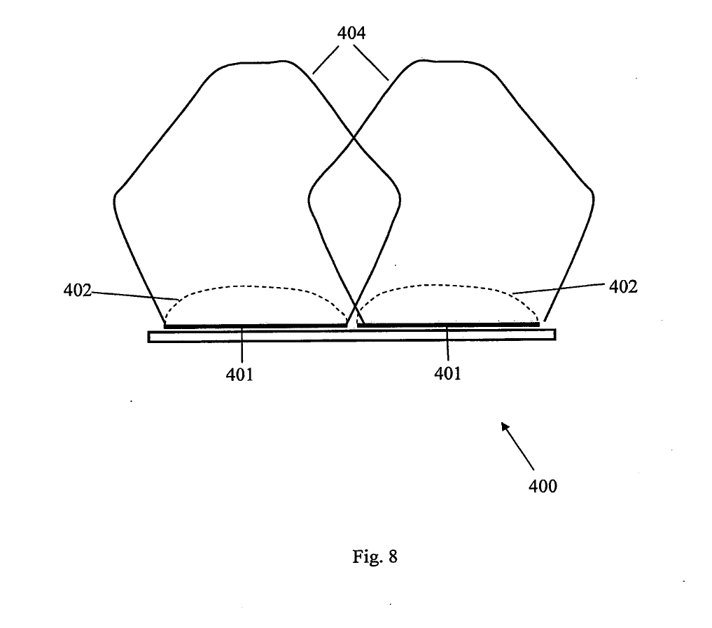

Attention is made now also to FIG. 8, which is a schematic side view illustration of performance curves of antenna array 400 according to embodiments of the present invention. In this side view of antenna array 400 two antenna elements 401 are seen, each having performance sensitivity curves 402, which may correspond, for example, to RFID tag AD-812 or performance sensitivity curves 404, which may correspond, for example, to RFID tags AD-430 or AD-222. It shall be noted that performance curves 402 and 404 were not drawn to scale.

According to some embodiments of the present invention, control unit 202 may update the contents of the display in interface unit 208 in an update rate that is faster than the rate of sequencer 204, thus ensuring a stable and trustworthy reading of the identified value of RFID tag for each antenna element in antenna array 206. A typical sequence time for update of the display in interface unit 208 may be in the range of 10-100 mSec.

Thus, a low profile (i.e. very thin), wide area antenna array comprising two or more antenna elements 50 may be activated and read according a defined time sequence, wherein each pair of adjacent spiral antenna elements 50 may have contradicting direction of windings, to provide a wide coverage area, with maximized height (i.e.—reading range) of each of the antenna elements, as the RFID tag may provide, while maintaining the transmission power within a defined level.

An antenna array such as array 206 may be used, for example, for on-going monitoring of inventory of products placed, for example, on shelves. In such embodiment each monitored product may be equipped with a RFID tag which may identify that product. The products may be stored on shelves and one or more antenna arrays according to the present invention may be installed, for example, at the shelf itself, with their active face aiming towards the products on the shelf Any change in the inventory of products on such shelf; e.g. addition of product, subtraction of product or moving of a product from one shelf to another may be identified in the next scan cycle of the respective shelves. A RFID system according to the present invention may be used, for example, in monitoring presence and time of arrival and/or of departure of persons in events such as a Marathon race with multiple participants or any other event in which the presence of plurality of single items should be continuously monitored. In order to ensure proper operation of such system measures should be taken to ensure that any of the monitored items stays within the sensing area of a single antenna element long enough to at least allow steady reading from said antenna element.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An apparatus comprising:
a conductive thin material arranged in planar spiral, having an outer end and an inner end; and
a transmit/receive terminal positioned at said outer end to receive inbound and outbound RF signals.

2. The apparatus of claim 1, wherein said spiral is placed on a non-conductive substrate.

3. The apparatus of claim 1, wherein the number and density of windings of said spiral is determined so that the RF magnetic field energy transmitted by said apparatus is relatively uniform close to said spiral and across the area overlapping said spiral.

4. The apparatus of claim 1, wherein magnetic field energy is relatively uniform in the near-field range from said apparatus.

5. An antenna array comprising:
a plurality of antenna apparatuses, each antenna apparatus comprising:
a conductive thin material arranged in planar spiral, having an outer end and an inner end; and
a transmit/receive terminal positioned at said outer end to receive inbound and outbound RF signals;
wherein said plurality of antenna apparatuses are arranged in a quadrangle array, and
wherein the direction of the spiral winding rotation in every pair of adjacent antenna apparatuses is inverted with respect to each-other.

6. The antenna array of claim 5, wherein said transmit/receive terminals of said plurality of antenna apparatuses are feed-able independently of each other.

7. The antenna array of claim 6, wherein RF signal is fed to said transmit/receive terminals of said plurality of antenna apparatuses sequentially.

8. The antenna array of claim 6 wherein said RF signal is fed to and is received from said transmit/receive terminals one at a time.

9. A method comprising:
providing a RF signal to an antenna having a conductive thin material arranged in planar spiral, and a transmit/receive terminal at its outer end;
receiving a response RF signal from a RFID tag; and
sending said received response to a control unit.

10. The method of claim 9 wherein said provided RF signal is distributed to plurality of said antenna one at a time for a defined period of time and said received RF signal is received from the energized antenna during said period of time.

11. A method comprising:
providing an array of plurality of antennas, each antenna having a conductive thin material arranged in planar spiral, and a transmit/receive terminal at its outer end and the direction of the spiral windings of every pair of adjacent antennas is inversed;
providing a RF signal to each of said terminals separately according to a time sequence and receiving a RFID response; and
presenting to a user an identification information based on an analysis of said received RFID response.

12. A Radio Frequency Identification (RFID) system comprising:
at least one array of antennas comprising:
a plurality of antenna apparatuses, each antenna apparatus comprising:
a conductive thin material arranged in planar spiral, having an outer end and an inner end; and
a transmit/receive terminal positioned at said outer end to receive inbound and outbound RF signals;
wherein said plurality of antenna apparatuses are arranged in a quadrangle array, and
wherein the direction of the spiral winding rotation in every pair of adjacent antenna apparatuses is inverted with respect to each-other.
a multi-way switch for each of said at least one array of antennas to provide RFID signal to at least one of said plurality of said antenna apparatuses; and
a sequencer for each of said at least one array of antennas to control said providing of RFID signal to said at least one of said plurality of said antenna apparatuses.

13. The system of claim 12, wherein said RFID signal is provided to said at least one of said plurality of said antenna apparatuses one-at-a-time.
